(19) United States
(12) Patent Application Publication
(10) Pub. No.: US 2013/0018990 A1
(43) Pub. Date: Jan. 17, 2013

(54) NEGOTIATIONS FOR ALTERNATE DOWNLOAD OPTIONS BETWEEN AN END USER AND A SERVER

(71) Applicants: Yigang Cai, Naperville, IL (US); Suzann Hua, Lisle, IL (US)

(72) Inventors: Yigang Cai, Naperville, IL (US); Suzann Hua, Lisle, IL (US)

(21) Appl. No.: 13/183,216

(22) Filed: Jul. 14, 2011

(51) Int. Cl. G06F 15/16

(52) U.S. Cl. 709/219

(57) ABSTRACT

Systems and methods are disclosed for negotiating alternate download options for downloading a file from a server to an end user device. A device in one embodiment transmits a first request to a server over a network to download a file from the server. The download is not available due to resource limitations in the network or the server itself. Thus, the device receives a response from the server indicating that the download is not available. The device processes the response to identify alternate download options offered by the server for downloading the file. The device detects a selection by the end user of one of the alternate download options, and generates a second request that includes an indication of the selected option. The device then transmits the second request to the server.

### FIELD OF THE INVENTION

The invention is related to the field of communication systems and, in particular, to systems and methods that allow for end users to negotiate alternate options with a server for downloading a file when a network is experiencing congestion.

### BACKGROUND

Computer and phone users are able to download many types of files from the internet, such as applications, movies, songs, video clips, etc. As more files become available via the internet and more users are accessing the files, network resources can become overloaded. As a result, the network may not be able to provide the download quality expected by the users, or may not be able to provide the download at all.

Assume for example that an end user subscribes to a service plan for internet access for a monthly fee. If the end user wants to download a movie via the internet, then the user's device (e.g., a computer or phone) sends a request to the appropriate server to download the movie. The server may provide the movie for free or may charge for the download. If the network is experiencing moderate congestion at the time of the download request, then the server may not be able to download the movie to the device with the speed as expected by the end user. If the network is experiencing high congestion at the time of the download request, the server may deny the download of the movie all together. Either way, the end user will not receive the movie from the server as expected based on his/her service plan.

### SUMMARY

Embodiments described herein allow for an end user to negotiate with the server for alternate download options in real-time. When the end user requests to download a file and the network is experiencing congestion, the server may determine one or more alternate options for downloading the file. For example, one option may be to download the file at the present time at a higher rate (cost). Another option may be to download the file at a later time at a reduced rate. The server provides the alternate download options to the user's device, and the device is able to display the options to the end user. The end user may then select one of the alternate download options for downloading the file. Therefore, when the requested download is not available with the quality, schedule, and/or price as expected due to network congestion, the server is able to offer the alternate download options to the end user in real-time instead of simply denying the download. The end user can then pick a “best fit” option based on his/her desire.

One embodiment comprises an end user device that supports negotiation for alternate download options. The device includes a network interface operable to transmit a first request to a server over a network to download a file from the server. The download is not available or the download could not be offered with expected quality/schedule due to resource limitations in the network or the server itself. Thus, the network interface is further operable to receive a response from the server over the network indicating that the download is not available. The device further includes a controller operable to process the response to identify alternate download options offered by the server for downloading the file. The alternate download options differ from a service plan of an end user of the device, such as in quality, schedule, and/or price. The controller is further operable to detect a selection by the end user of one of the alternate download options, and to generate a second request that includes an indication of the selected option. The network interface is further operable to transmit the second request to the server.

Another embodiment comprises a server that supports negotiation for alternate download options. The server includes a network interface operable to receive a first request from an end user device over a network to download a file. The server further includes a controller operable to determine that the download is not available due to resource limitations in the network or the server itself, to determine alternate download options for downloading the file that differ from a service plan of the end user, and to generate a response that includes the alternate download options as an offer to the end user. The network interface is further operable to transmit the response to the end user device over the network.

The network interface of the server is further operable to receive a second request from the end user device that includes an indication of a selected one of the alternate download options. The server controller is further operable to initiate download of the file to the end user device based on the selected option.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication system in an exemplary embodiment.

FIG. 2 illustrates an end user device in an exemplary embodiment.

FIG. 3 illustrates a server in an exemplary embodiment.

FIG. 4 is a flow chart illustrating a method of operating an end user device for negotiating alternate download options in an exemplary embodiment.

FIG. 5 is a flow chart illustrating a method of operating a server for negotiating alternate download options in an exemplary embodiment.

FIG. 6 illustrates a communication system in another exemplary embodiment.

FIG. 7 illustrates an end user device displaying alternate download options to an end user in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended to aid in understanding the principles of the invention, and are to be construed as being without limitation to such specifically recited examples and conditions. As a result, the invention is not limited to the specific embodiments or examples described below, but by the claims and their equivalents.

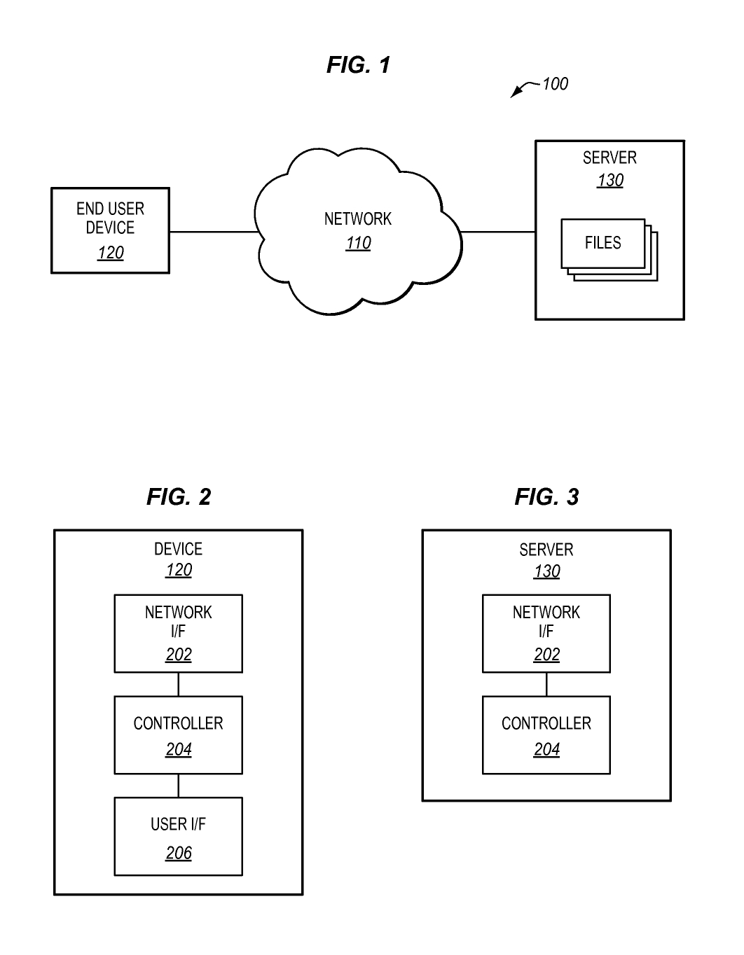

FIG. 1 illustrates a communication system 100 in an exemplary embodiment. Communication system 100 includes a network 110 that connects an end user device 120 to a server 130. Network 110 may comprise an Internet Protocol (IP) network, such as the internet, a mobile network, such as a Long Term Evolution (LTE) network, an IP Multimedia Subsystem (IMS) network, or another type of network. Device 120 comprises any type of computer, phone, etc, that is able to download files from server 130 over network 110. Server 130 stores one or more files that are downloadable over network 110. A file comprises a collection of data, such as a document, picture, audio or video stream, application, etc.

In the embodiments described below, the end user of device 120 desires to download files from server 130. One assumption is that the end user has subscribed to a service that allows for the download of files from server 130. For example, the end user may subscribe to a service that allows access to network 110, such as an internet service where the end user enters into a service contract with a provider that includes a service level agreement (SLA). The end user may also subscribe to a service provided by server 130 for downloading files. For instance, if server 120 stores movies or songs for download, then the end user may subscribe to a download service provided by server 130 for a monthly fee or a per-download fee. The subscription to the download service is generally referred to herein as a service plan. Through this service plan, the end user has some expectations of the quality (e.g., bandwidth or QoS), schedule, and/or price in downloading files from server 130 or other servers not shown.

When requesting a file download, the resources in network 110 and/or server 130 are overloaded so that the download of the file is not available based on the expectations of the end user (e.g., during a peak time for network 110). Instead of the file download failing, the embodiments described below allow the end user and server 130 to negotiate alternate download options so that the end user is still able to download the file even though network conditions may be poor.

FIG. 2 illustrates device 120 in an exemplary embodiment. Device 120 includes a network interface 202, a controller 204, and a user interface 206. Network interface 202 comprises any components, devices, or functions operable to exchange communications with other elements (e.g., server 130) over network 110. Controller 204 comprises any components, devices, or functions operable to negotiate alternatives for downloading a file from a server. User interface 206 comprises any components, devices, or functions operable to receive input from an end user, such as a keypad, a pointing device, etc, and/or convey content to the end user, such as a display, a speaker, etc.

FIG. 3 illustrates server 130 in an exemplary embodiment. Server 130 includes a network interface 302 and a controller 304. Network interface 302 comprises any components, devices, or functions operable to exchange communications with other elements (e.g., device 120) over network 110. Controller 304 comprises any components, devices, or functions operable to negotiate alternatives for downloading a file to a requesting device.

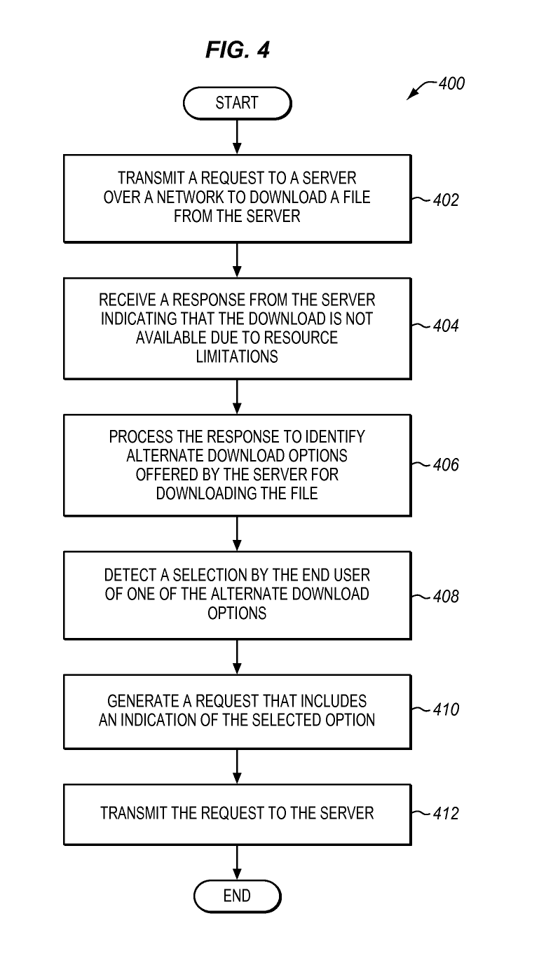

Assume for one embodiment that the end user of device 120 wants to download a file from server 130. Device 120 runs an application, such as a web browser, to allow the end user to select the desired file for download. When resource limitations prohibit the file from being available for download, the end user may negotiate for alternate download options as illustrated in FIG. 4.

FIG. 4 is a flow chart illustrating a method 400 of operating device 120 for negotiating alternate download options in an exemplary embodiment. The steps of method 400 are described with reference to communication system 100 in FIG. 1 and device 120 in FIG. 2, although method 400 may be performed in other devices or systems. The steps of the flow charts described herein are not all inclusive and may include other steps not shown. The steps may also be performed in an alternative order.

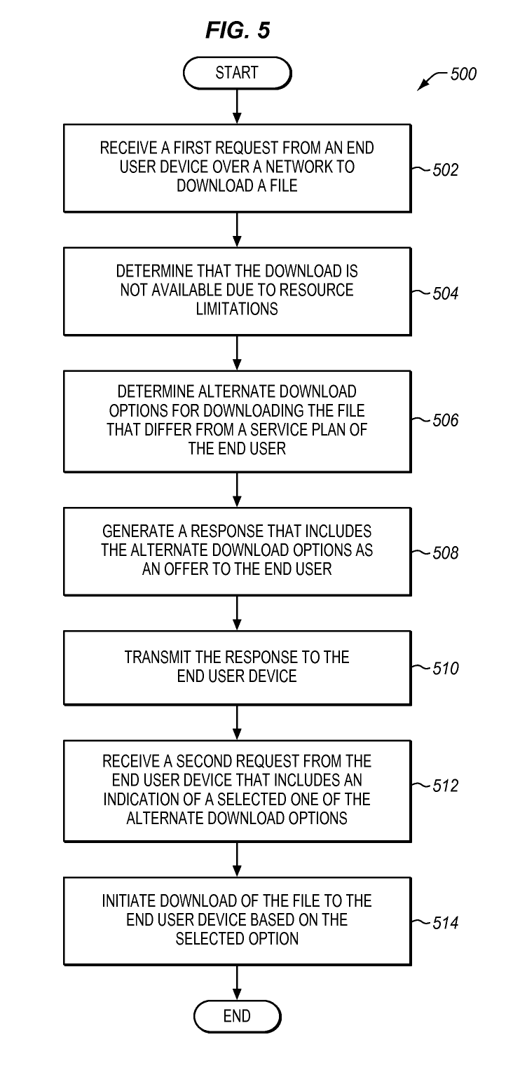

In step 402, network interface 202 transmits a request to server 130 over network 110 to download the file. The request may comprise a Hypertext Transfer Protocol (HTTP) GET or a request of another protocol. As discussed above, device 120 is enabled to negotiate with server 130 for alternate download options. Therefore, network interface 202 may insert an indication in the request that device 120 supports negotiation with server 130. If the request is an HTTP GET, then network interface 202 may insert the indication in a parameter or field of the HTTP GET. Server 130 may then operate as described in FIG. 5 to continue with the negotiations.

FIG. 5 is a flow chart illustrating a method 500 of operating server 130 for negotiating the alternate download options in an exemplary embodiment. The steps of method 500 are described with reference to communication system 100 in FIG. 1 and server 130 in FIG. 3, although method 500 may be performed in other nodes or systems.

In step 502, network interface 302 of server 130 receives the download request from device 120. In step 504, controller 304 determines that the download is not available due to resource limitations in network 110 and/or server 130. In step 506, controller 306 determines alternate download options for downloading the file to device 120. The alternate download options comprise one or more conditions for download that differ from a service plan of the end user. For example, the alternate download options may include an alternate bandwidth that differs from the service plan of the end user. In another example, the alternate download options include an alternate rate/cost/price that differs from the service plan of the end user. For instance, if the rate for the download of a movie is $7.99, then the alternate rate may be higher or lower than that rate. In yet another example, the alternate download options may include an alternate download time. Typically, the expected time for download is immediate. Thus, an alternate time may be to begin download of the file after an hour, 2 hours, 3 hours, etc.

After determining the alternate download options, controller 304 generates a response that includes the alternate download options as an offer to the end user in step 508. The response may comprise an HTTP 200 OK or a response of another protocol. If so, controller 304 may insert the alternate download options in a parameter or field of the HTTP 200 OK. In step 510, network interface 302 transmits the response to device 120. The negotiation then returns to the end user side in FIG. 4.

Looking again at the negotiation from the end user side, network interface 202 (see FIG. 2) of device 120 receives the response from server 130 in step 404. The response from server 130 indicates that the file download is not available due to resource limitations in network 110 and/or server 130. Therefore, controller 204 processes the response to identify the alternate download options offered by server 130 for downloading the file in step 406. Controller 204 then provides (e.g., displays) the options to the end user for selection. For example, controller 204 may convert or translate the alternate download options into user-readable text, and display the text of the alternate download options to the end user through user interface 206. The end user may then select one of the options displayed by device 120, and user interface 206 receives the input from the end user of the selected option.

Controller 204 detects the selection by the end user in step 408, and generates another request that includes the selected option in step 410. This request may comprise another HTTP GET or a request of another protocol. If the request is an HTTP GET, then controller 204 may insert an indication of the selected option in a parameter or field of the HTTP GET. Network interface 202 then transmits the request to server 130 in step 412. The negotiation then returns to the server side in FIG. 5.

In FIG. 5, network interface 302 of server 130 (see FIG. 3) receives the request from device 120 that includes the selected option in step 512. Controller 304 then initiates download of the file to device 120 based on the selected option in step 514. For example, if the end user selected to download the file immediately at a higher rate, then controller 304 initiates the file download and charges for the download at the higher rate. If the end user selected to download the file at a later time at a reduced rate, then controller 304 initiates the file download at the agreed-to time and charges for the download at the lower rate.

By allowing the end user to negotiate alternate download options, the end user may still receive the file from server 130 even though the conditions of network 110 or server 130 are poor. Therefore, the end user will more likely be satisfied with his/her service and remain as a customer.

### Example

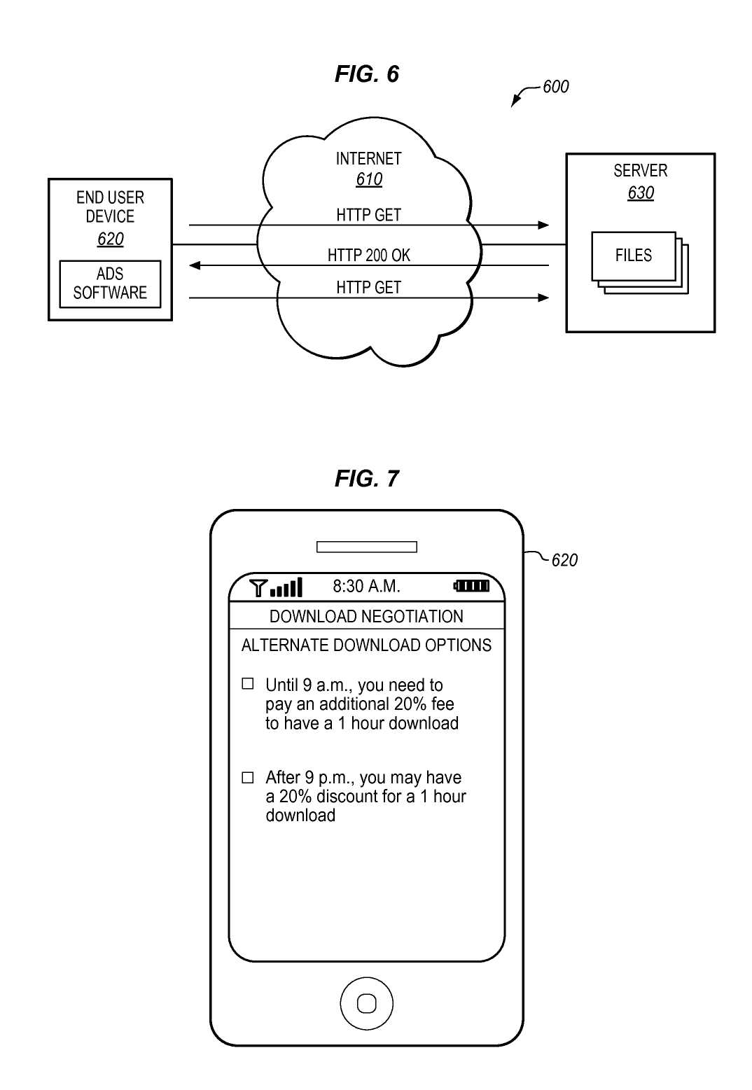

FIG. 6 illustrates a communication system 600 in another exemplary embodiment. Communication system 600 includes an internet 610 that connects an end user device 620 to a server 630. This example illustrates HTTP negotiation between an end user of device 620 and server 630 for alternate download options when internet 610 and/or server 630 have resource limitations. To provide HTTP negotiations, Alternate Downloading Service (ADS) software may be installed on device 620. The ADS software supports parameters for negotiating with server 630 for downloading a file. One parameter, such as “accept-negotiation”, may be used to indicate to server 630 that device 620 supports HTTP negotiation for alternate download options. When device 620 initiates a download request via an HTTP GET message, the ADS software inserts the parameter “accept-negotiation” in the HTTP GET message. When internet 610 and/or server 630 experience resource limitations making the requested download unavailable with the quality, schedule, and/or price expected by the end user, device 620 will receive an HTTP response from server 630, such as an HTTP 200 OK. The ADS software of device 620 supports additional parameters, such as “slow-until”, “fast-price-until”, and “fast-price-after”, that are received in the HTTP response as alternate download options offered by server 630. The ADS software checks if the HTTP response includes one or more of these parameters as alternate download options. If so, the ADS software translates the options to plain language, and presents the options to the end user (e.g., displays the options on a screen of device 620).

In one example, the ADS software checks the HTTP response for the parameter “slow-until: estimated transaction duration, until-when” as an alternate download option. The ADS software is able to translate the “slow-until” values to plain language, and present the option to the end user. For instance, if the option reads “slow-until: 3 hrs, 11 pm”, then the ADS software may present the option in plain language to the end user as “Until 11 pm, your estimated download time is about 3 hours”.

In another example, the ADS software checks the HTTP response for the parameter “fast-price-until: estimated transaction duration, additional price, until-when” as an alternate download option. The ADS software is able to translate the “fast-price-until” values to plain language, and present the option to the end user. For instance, if the option reads “fast-price-until: 1 hr, +20%, 9 am”, then the ADS software may present the option in plain language to the end user as “Until 9 a.m., you need to pay an additional 20% fee to have a 1 hour download”.

In another example, the ADS software checks the HTTP response for the parameter “fast-price-after: estimated transaction duration, additional price, after-when” as an alternate download option. The ADS software is able to translate the “fast-price-after” values to plain language, and present the option to the end user. For instance, if the option reads “fast-price-after: 1 hr, −20%, 9 pm”, then the ADS software may present the option in plain language to the end user as “After 9 p.m., you may have a 20% discount for a 1 hour download”.

In addition to presenting the alternate download options to the end user, the ADS software allows the end user to select one of the options. For example, the ADS software may provide check box beside each of the alternate download options for the end user to select. The end user may then select one of options or simply quit the download request. If the end user selects one of the options, then the ADS software resends the HTTP GET message with the selected option. If the end user selected “fast-price-after” option, then the ADS software will automatically resend the HTTP GET message at the specified “after-when” time.

To provide HTTP negotiations from the server side, server 630 supports a parameter in an HTTP GET message that indicates whether or not device 620 is able to perform HTTP negotiation for alternate download options, such as “accept-negotiation”. The HTTP GET message requests the download of a file. Server 630 is also able to detect its own resource limitation or some type of resource limitation in internet 610. For example, if internet 610 is experiencing congestion during a peak time, then server 630 is able to detect the congestion and determine that the requested download is unavailable to device 620 at the quality, schedule, and/or price expected by the end user. Server 630 is also able to determine alternate download options that are offered to device 620 in an HTTP response. The alternate download options are offered to device 620 using parameters in the HTTP response, such as “slow-until”, “fast-price-until” and “fast-price-after”. These options are offered to device 620 when the HTTP GET message includes the “accept-negotiation” parameter indicating that device 620 supports HTTP negotiation.

For example, if server 630 is currently experiencing a minor jam condition, then server 630 may offer a fast service (treat the request as high priority transaction task) for an additional fee (via “fast-price-until” parameter), and indicate the time that the fast service will be available. If server 630 is currently experiencing a minor jam condition, then server 630 may offer a slow service without additional charge (via “slow-until” parameter), and indicate the time that the slow service will be available. If server 630 is currently experiencing a jam condition, then server 630 may offer a fast service with a discounted price (via “fast-price-after” parameter) at specified future time. If server 630 is currently in an idle condition, then server 630 may offer a fast service without additional price (via “fast-price-until” parameter), and indicate the time that the fast service will be available.

To illustrate an exemplary negotiation, assume an end user of device 620 wants to download a file from server 630. Thus, device 620 generates an HTTP GET message requesting the download, and inserts an indication in the HTTP GET message that device 620 supports HTTP negotiation. An example of the HTTP GET message is as follows:

GET /openapi/sms/rest/v1.0/registration/7777/messages HTTP/1.1
Authorization: Basic XMVDTdx+
X-Partner-Id: ACP123@acp.alcatel-lucent.com
X-Service-Id: APP123@ACP123
Host: acp.alcatel-lucent.com
Accept application/json
Content-Length: (...)
{“downloadInformation”:“:[{“alternateDownloadOptions”:“accept-
negotiation”}

The “accept-negotiation” parameter indicates that device 620 supports HTTP negotiation. Device 620 then sends the HTTP GET to server 620 over internet 610.

In response to the HTTP GET, server 620 determines that the download is not available due to resource limitations in internet 610 or within server 620 itself. When this occurs, server 620 determines alternate download options for downloading the file. The alternate download options differ from a service plan of the end user. For example, assume that server 630 provides a service for downloading movies at a rate of $7.99 per download. When the end user subscribes to the service, the end user expects to receive an immediate download of the movie for the cost of $7.99 per download. The end user also expects the download to be completed in a reasonable time based on the size of the movie and the download speed typically available to device 620. If internet 610 is congested at the time of the download request, then server 620 may not be able to perform the download as expected by the end user. Thus, server 620 determines the alternate download options for downloading the file.

To provide the alternate download options to the end user, server 630 generates an HTTP 200 OK message, and inserts the alternate download options in parameters of the HTTP 200 OK message as an offer to the end user. An example of the HTTP 200 OK message is as follows:

```
    HTTP/1.1 200 OK
    Content-Type: application/json
    Content-Length: (...)
    {“downloadInformation”:“:[{“DownloadNegotiationOptions”:
{“option”:“fast-price-until: 1hr, +20%, 9pm”,“option”:“fast-price-after:
1hr, −20%, 9pm”}]}
```

The “fast-price-until” and “fast-price-after” parameters indicate the alternate download options that are being offered to the end user. The “fast-price-until” parameter indicates one option that a 1 hour download is available at a higher rate (+20%) until 9 p.m. The “fast-price-after” parameter indicates another option that a 1 hour download is available at a later time (9 p.m.) at a reduced rate (−20%). Server 620 then sends the HTTP 200 OK to device 620.

In response to the HTTP 200 OK, the ADS software in device 620 processes the 200 OK to identify the alternate download options offered by server 630. The ADS software translates the options to plain language, and displays the options to the end user. For example, the ADS software translates the “fast-price-until” values to plain language, such as “Until 9 a.m., you need to pay an additional 20% fee to have a 1 hour download”. The ADS software also translates the “fast-price-after” values to plain language, such as “After 9 p.m., you may have a 20% discount for a 1 hour download”. FIG. 7 illustrates device 620 displaying the alternate download options to the end user in an exemplary embodiment.

The end user may then evaluate the options, and select one of the options to download the requested file. Assume that the end user determines that he/she wants an immediate download of the file with an additional 20% charge. Thus, the end user selects the “fast-price-until” option. The ADS software then generates another HTTP GET message, and inserts the selection of the end user into the HTTP GET. The ADS software then transmits the HTTP GET message to server 630. An example of the HTTP GET message is as follows:

GET /openapi/sms/rest/v1.0/registration/7777/messages HTTP/1.1
Authorization: Basic XMVDTdx+
X-Partner-Id: ACP123@acp.alcatel-lucent.com
X-Service-Id: APP123@ACP123
Host: acp.alcatel-lucent.com
Accept application/json
Content-Length: (...)
{“downloadInformation”:[{“downloadNegotiationOptions”:{“option”:
“fast-price-until: 1hr, +20%, 9am”}]}

Server 630 receives the HTTP GET, and processes the selected option from the end user. Server 630 then initiates download of the file to device 620 based on the selected option. In this example, server 630 treats the download request from the end user as a high-priority transaction task, and immediately begins the download. Server 630 will then charge the end user at a 20% higher rate for the immediate download.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Although specific embodiments were described herein, the scope of the invention is not limited to those specific embodiments. The scope of the invention is defined by the following claims and any equivalents thereof.

We claim:

1. A device comprising:
a network interface operable to transmit a first request to a server over a network to download a file from the server, and to receive a response from the server indicating that the download is not available due to resource limitations; and
a controller operable to process the response to identify alternate download options offered by the server for downloading the file that differ from a service plan of an end user of the device, to detect a selection by the end user of one of the alternate download options, and to generate a second request that includes an indication of the selected option;
the network interface further operable to transmit the second request to the server.

2. The device of claim 1 further comprising:
a user interface;
wherein the controller is further operable to convert the alternate download options into user-readable text, and to display the text of the alternate download options to the end user through the user interface;
wherein the user interface is operable to receive input from the end user selecting the one of the alternate download options.

3. The device of claim 1 wherein:
the alternate download options include an alternate download bandwidth that differs from the service plan of the end user.

4. The device of claim 1 wherein:
the alternate download options include an alternate download cost that differs from the service plan of the end user.

5. The device of claim 1 wherein:
the alternate download options include an alternate download time.

6. The device of claim 1 wherein:
the first request comprises a first Hypertext Transfer Protocol (HTTP) GET; and
the controller is further operable to insert an indication that the device supports negotiation with the server for the alternate download options in a parameter of the first HTTP GET.

7. The device of claim 6 wherein:
the second request comprises a second HTTP GET; and
the controller is further operable to insert the indication of the selected option in a parameter of the second HTTP GET.

8. A method comprising:
transmitting a first request from an end user device to a server over a network to download a file from the server;
receiving a response in the end user device from the server indicating that the download is not available due to resource limitations;
processing the response in the end user device to identify alternate download options offered by the server for downloading the file that differ from a service plan of an end user of the device;
detecting a selection by the end user of one of the alternate download options;
generating a second request that includes an indication of the selected option; and
transmitting the second request from the end user device to the server.

9. The method of claim 8 wherein detecting a selection by the end user of one of the alternate download options comprises:
converting the alternate download options into user-readable text;
displaying the text of the alternate download options to the end user; and
receiving input from the end user selecting the one of the alternate download options.

10. The method of claim 8 wherein:
the alternate download options include an alternate download bandwidth that differs from the service plan of the end user.

11. The method of claim 8 wherein:
the alternate download options include an alternate download cost that differs from the service plan of the end user.

12. The method of claim 8 wherein:
the alternate download options include an alternate download time.

13. The method of claim 8 wherein:
the first request comprises a first Hypertext Transfer Protocol (HTTP) GET; and
the method further comprises inserting an indication that the end user device supports negotiation with the server for the alternate download options in a parameter of the first HTTP GET.

14. The method of claim 13 wherein:
the second request comprises a second HTTP GET; and
the method further comprises inserting the indication of the selected option in a parameter of the second HTTP GET.

15. A system comprising:
a network interface operable to receive a first request from an end user device over a network to download a file; and
a controller operable to determine that the download is not available due to resource limitations, to determine alternate download options for downloading the file that differ from a service plan of the end user, and to generate a response that includes the alternate download options as an offer to the end user;
the network interface further operable to transmit the response to the end user device.

16. The system of claim 15 wherein:
the network interface is further operable to receive a second request from the end user device that includes an indication of a selected one of the alternate download options; and
the controller is further operable to initiate download of the file to the end user device based on the selected option.

17. The system of claim 15 wherein:
the alternate download options include an alternate download bandwidth that differs from the service plan of the end user.

18. The system of claim 15 wherein:
the alternate download options include an alternate download cost that differs from the service plan of the end user.

19. The system of claim 15 wherein:
the alternate download options include an alternate download time.

20. The system of claim 15 wherein:
the first request comprises a first Hypertext Transfer Protocol (HTTP) GET and the response comprises an HTTP 200 OK; and
the controller is further operable to insert the alternate download options in a parameter of the HTTP 200 OK.

21. A method comprising:
receiving a first request from an end user device over a network into a server to download a file;
determining that the download is not available due to resource limitations;
determining alternate download options for downloading the file that differ from a service plan of the end user;
generating a response that includes the alternate download options as an offer to the end user; and
transmitting the response from the server to the end user device.

22. The method of claim 21 further comprising:
receiving a second request in the server from the end user device that includes an indication of a selected one of the alternate download options; and
initiating download of the file from the server to the end user device based on the selected option.

23. The method of claim 21 wherein:
the alternate download options include an alternate download bandwidth that differs from the service plan of the end user.

24. The method of claim 21 wherein:
the alternate download options include an alternate download cost that differs from the service plan of the end user.

25. The method of claim 21 wherein:
the alternate download options include an alternate download time.

26. The method of claim 21 wherein:
the first request comprises a first Hypertext Transfer Protocol (HTTP) GET and the response comprises an HTTP 200 OK; and
the method further includes inserting the alternate download options in a parameter of the HTTP 200 OK.
